(19) United States
(12) Patent Application Publication
(10) Pub. No.: US 2012/0316997 A1
(43) Pub. Date: Dec. 13, 2012

(54) SYSTEM AND METHOD FOR INTRODUCING A BUYER TO THE SELLER OF A VEHICLE USING INFORMATION COLLECTED WHEN ASSESSING THE TRADE-IN VALUE OF THE VEHICLE

(76) Inventor: Adam HERBERT, Richmond, VA (US)

(21) Appl. No.: 13/155,586

(22) Filed: Jun. 8, 2011

(51) Int. Cl. G06Q 30/00

(52) U.S. Cl. 705/27.1

(57) ABSTRACT

A system and method fill a void between the wholesale, retail and private party markets for vehicles, bringing together private party buyers with sellers who rejected a trade-in value for a vehicle from a dealership. The system comprises a dealership computer into which vehicle information is entered for ascertaining a trade-in value for the vehicle. A private party computer is located remotely from the dealership computer but connected to the dealership computer to publish the vehicle information on the private party computer to solicit a private party buyer for the vehicle. The method comprises the step of a dealership publishing the vehicle information on a computer network so that the information is searchable by remotely located private party buyers. The dealership receives notice that the private party buyer may be interested in buying the vehicle, and notifies the customer.

### BACKGROUND

This subject matter described herein relates in general to data processing, and more particularly to a system and method for introducing a private party buyer to the private party seller of a vehicle that was considered as a trade-in vehicle at a dealership.

Customers typically offer vehicles for trade toward the purchase of a new vehicle (i.e., a new or used vehicle). The trade-in vehicle is considered as a partial payment toward the new vehicle. When considering a trade-in vehicle, the dealership must ascertain its value. The value is ascertained by collecting information about the vehicle, including the vehicle identification number, the year, make and model of the vehicle, the trim package, the mileage, the maintenance or repair history, and the cosmetic and operating condition of the vehicle. Often, pictures of the vehicle are taken as to memorialize the cosmetic condition. The vehicle identification number can be checked against a commercial web-based service that provides vehicle history reports. Once information about the vehicle has been collected, the dealership estimates the trade-in value of the vehicle based on historical sales information in the region of the dealership.

Often, dealerships will only offer a true wholesale value for trade-in vehicles. This is typically the lowest possible value that the vehicle will fetch for the dealership if the vehicle is sold at an auction. Generally, the sale value for the vehicle at the dealership is considerably higher, while the private party sale value for the vehicle is at a medial point between the true wholesale value and the dealership sale value. For example, if a dealership offers $10,000 for a trade-in vehicle, the dealership expects to sell the vehicle for a price in a range from $14,000 to $16,000. A private party can expect to sell the vehicle for about $12,000, $2,000 more than the value that the dealership offered as a trade-in value (i.e., the true wholesale value).

If the dealership's offer (i.e., the true wholesale value) is unacceptable to the customer, no sale takes place. The deal is dead. The customer leaves the dealership, and the dealership focuses its attention on another customer. After a few weeks, the dealership forgets about the trade-in vehicle. The trade information goes unused.

### SUMMARY

Described herein is a novel system and method for filling a void between the wholesale, retail and private party markets for vehicles. The system and method bring together potential private party buyers with sellers who could not come to an agreeable trade-in value for a vehicle at a dealership.

The system comprises a dealership computer into which vehicle information is entered for ascertaining a trade-in value for a private party vehicle. A private party computer is located remotely from the dealership computer and connected to the dealership computer so as to publish the vehicle information on the private party computer to solicit a private party buyer for the private party vehicle.

The method comprises the step of a dealership publishing the vehicle information on a computer network so that the information is searchable by remotely located private party buyers. The dealership receives notice that the private party buyer may be interested in buying the vehicle. The dealership notifies the customer that the private party buyer may be interested in buying the vehicle.

### BRIEF DESCRIPTION OF THE DRAWINGS

FIG. 1 is a schematic representation of a system for use in introducing a private party buyer to a private party seller of a vehicle.

FIG. 2 is a diagrammatic view of an exemplary browser that is published to a private party buyer.

FIG. 3 is a flow chart of a method for introducing a private party buyer to a private party seller of a vehicle.

FIG. 4 is a diagrammatic view of an exemplary page that is accessible by a dealership.

### DETAILED DESCRIPTION

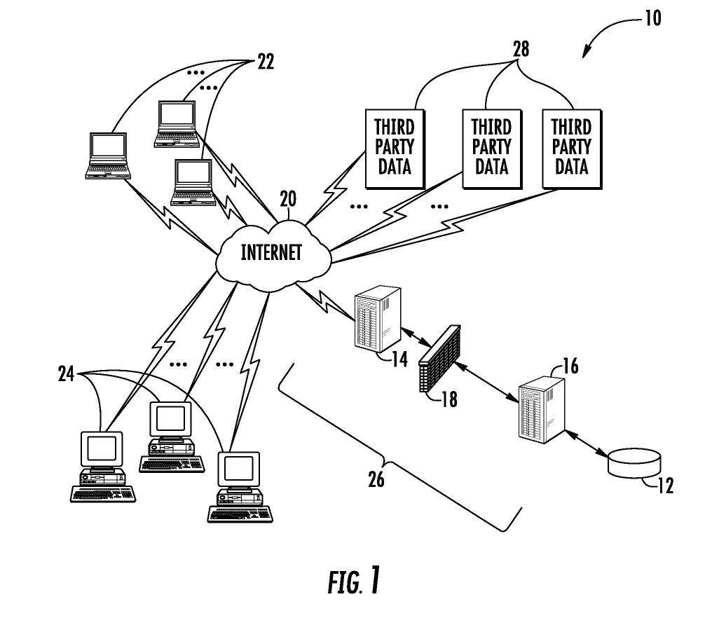

Referring now to the drawings, there is illustrated in FIG. 1 an interactive system that includes a computer network 10 for use in introducing a private party buyer to a private party seller of a vehicle that was considered as a trade toward a new vehicle (i.e., a new or used vehicle) at a dealership. In the description that follows, the term vehicle is used with reference to motor vehicles. However, the system and method to be described below can be used for any vehicle, including cars, trucks, boats, motorcycles or the like that are resold and have a value considering, for example, the year make, model and type of the vehicle, together with use and condition, accessories added, and repair history.

The computer network 10 is the medium used to provide communication links between various devices and computers connected within the system. The computer network 10 may include permanent connections, such as wire or fiber optic cables, or temporary connections made through telephone connections or wireless applications, and may be established, operated and maintained as known in the art. Although computer network 10 as described utilizes a global computer network, such as the Internet, it is to be understood that the methodology of the system could be practiced utilizing other computer or communications networks capable of interactive processing of data, and transmittal thereof to distant parties. That is to say, the network 10 may represent a worldwide collection of networks and gateways that use the TCP/IP suite of protocols to communicate with one another. Of course, the system may also be implemented as a number of different types of networks, such as, for example, an intranet, a local area network (LAN), or a wide area network (WAN).

In the exemplary embodiment, the computer network 10 is a computer network capable of making use of Internet applications and may include a main storage unit or database 12, servers 14, 16 (shown on opposite sides of a firewall 18 when viewing FIG. 1) that are selectively accessible through the Internet 20 by computers 22 (used by dealerships) and computers 24 (used by private party buyers), end users of computer network 10. The computer network 10 may also include additional servers, end user devices and other devices. End user devices may also include hand-held devices and other electronic devices. It should be appreciated that the servers 14, 16 may be placed on the same side of the firewall 18, and the database 12, the firewall 18 and the servers 14, 16 may be considered a single system server connected to the Internet 20 and therefore, for ease of description, shall be collectively referenced as the server 26, unless otherwise indicated.

The dealership computers 22 and the private party buyer computers 24 may use browsers to access the server 16, which, in conjunction with the server 14 and the database 12, may respond to requests and commands received from the browsers to generate an interactive network web site through which part of the methodology of the system may be practiced. To prevent unauthorized access, the computer network 10 may provide security measures, as is known in the art, by requiring an established account with a unique combination of an account number and/or user name and password.

The server 26 may provide access to data on the database 12, including access to data such as boot files, operating system images and applications to the end users. Access may be provided to electronic industry standard appraisal forms and condition reports and accurate book value information for ascertaining the value of vehicles. These forms, reports and information may be stored on the database 12, or directly on the dealership computers 22. Cameras may interface with the computer network 10 (e.g., via the dealership computers 22), and vehicle photos may be stored on the dealership computers 22 and/or the database 12.

The system is capable of maintaining an inventory of vehicles that is searchable by make, model, color, region, value and/or other vehicle properties. The methodology of the system may be carried out by a dynamic process relying on changing information. That is, vehicle information, as well as the date and time of submitting such information, and origin of such information, may change with time. New vehicles can be added to or removed from the system so that the available vehicles may be changed and/or updated constantly. It should be appreciated that dealerships in the various geographic regions may submit vehicle information on a real-time and/or scheduled basis. Vehicle information may be submitted manually and/or automatically (e.g., submitted according to a schedule). The vehicle information is published through the Internet 20 by the dealership and private party buyer computers 22, 24 via the browsers.

Book value information may be continuously updated and the private party sales value of the vehicles may depreciate over time. Data regarding the value of specific year, make and model of vehicles may be provided and/or updated online by accessing third-party database servers 28, which contain data to enable the system to ascertain private party sale values for vehicles, including real-time market values.

Book value information may be imported from various third-party database servers 28, which are available through the Internet, for determining vehicle values. Such servers 28, including servers available by BLACK BOOK® NATIONAL AUTO RESEARCH, KELLY BLUE BOOK®, NATIONAL AUTOMOBILE DEALERS ASSOCIATION® (NADA®), or the like, and others are known in the art. On a periodic basis, the server 26 may download information in the form of current vehicle values through Internet 20 from the third-party database servers 28 and store the downloaded information on the database 12. The downloaded information may be used to automatically update the value of the vehicles. The database 12 may be updated on a daily, weekly, monthly or any other periodic basis as appropriate to keep the information sufficiently current. It should be appreciated that the downloaded information may also be made available through the Internet 20 to the dealership computers 22 and/or the private party buyer computers 24 from the browsers. It should be understood that vehicle and/or book value information may also be entered by hand (e.g., via a keyboard), a memory device (i.e., a CD ROM, a flash card, or the like), or any other known input method.

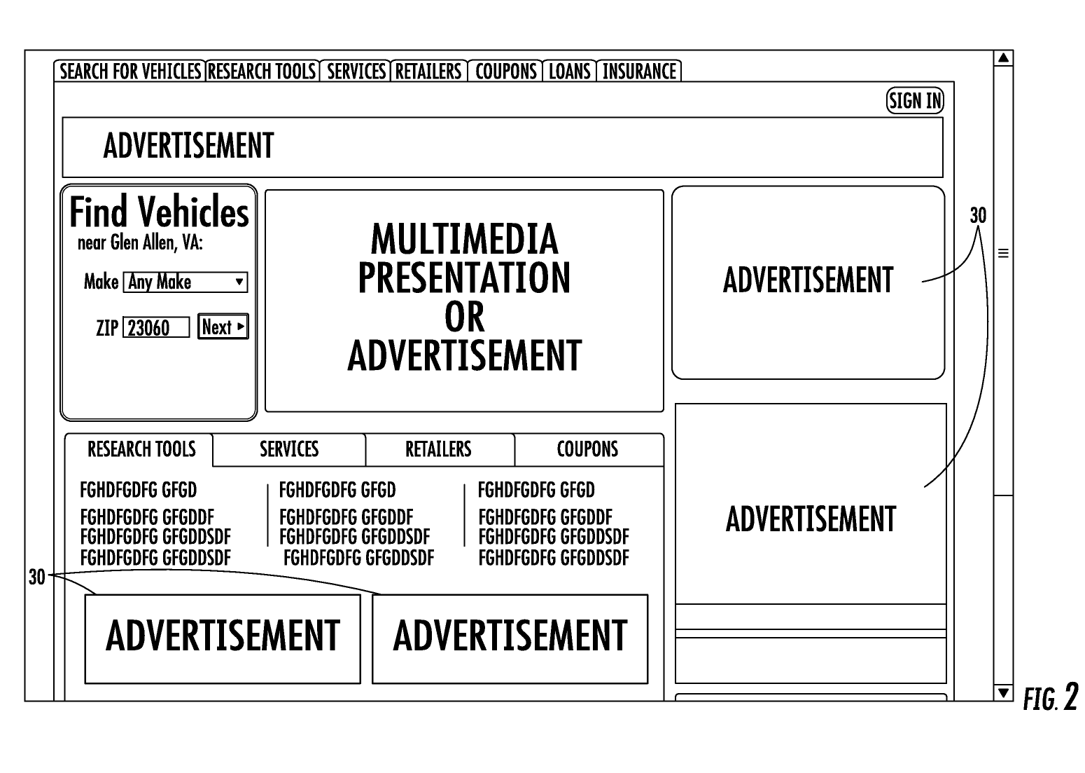

The system may publish other information, in the form of advertisements 30, through the Internet 20 by the dealership and private party buyer computers 22, 24 via the browsers, as shown in FIG. 2. Lending institutions (e.g., credit unions and banks) may advertise services. Such institutions may offer to provide loans and prequalify private party buyers. Insurers may advertise vehicle insurance services. Credit reporting agencies may advertise credit reporting services. Motor vehicle service centers may advertise services, such as inspection and/or repair service, and/or provide repair estimates. Other service providers may advertise services, such as detailing, dent removal, painting or paint touch-up, and vehicle transport services. Retailers may also advertise products, such as replacement parts, accessories and tools. Advertisements may include links directed to third party websites. Moreover, links may be provided to online coupons.

The system may also provide access to research tools and statistical data, and may allow vehicle comparisons. For example, the system may function to locate vehicles, provide historical sales data, permit vehicles to be placed in a watch list, provide alerts when new vehicles are published, and alert dealerships of potential buyers.

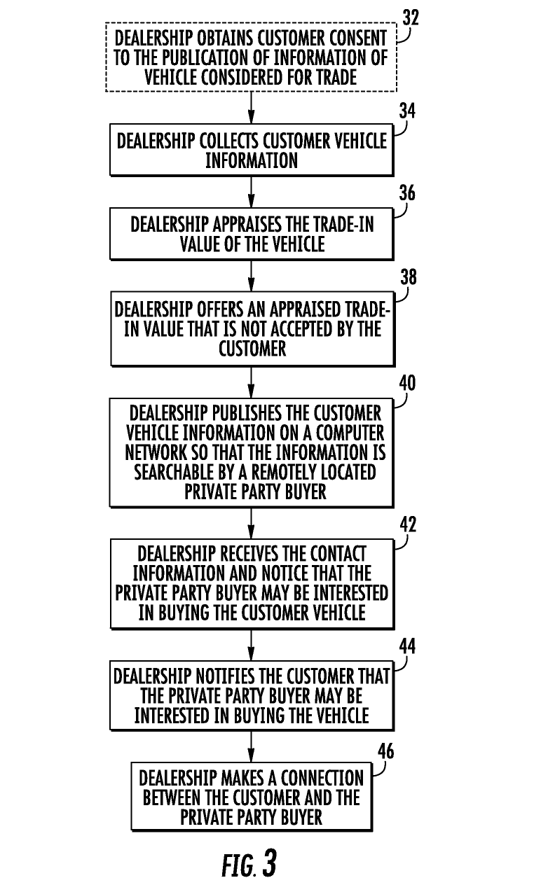

Reference is now made to FIG. 3 in which a flow chart for a method is provided for coordinating the sale of used vehicles between private party buyers and private party sellers, in which dealerships facilitate the sale utilizing the system.

A customer visits a dealership to shop for a new vehicle (i.e., new or used vehicle). The customer finds a new vehicle that the customer wants to buy. The customer wants to trade his or her current vehicle for the new vehicle, as partial payment toward the new vehicle. The trade-in value of the vehicle has to be ascertained via an appraisal process.

According to step 116, the dealership obtains customer consent for the publication of detailed information about the customer's vehicle. This can be done as part of the appraisal process.

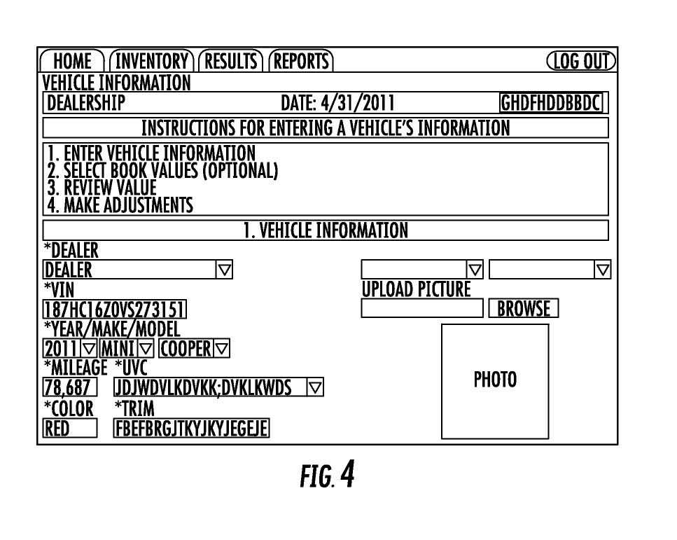

According to step 118, the dealership collects the detailed information about the vehicle. The vehicle information may be collected on the dealership computer 22, which may be presented with electronic forms and/or reports (e.g., industry standard appraisal forms and/or vehicle condition reports) that are populated with fields for data entry, as shown, for example, in FIG. 4. Drop down menus or other framework known in the art utilizing, for example, a graphical user interface (GUI) may be presented for managing the vehicle information or data. It should be appreciated that the forms and/or reports may be stored and displayed on the dealership computer 22, or stored on the server 26, which may be accessed by the dealership computer 22 through a web browser.

The vehicle information may include the vehicle identification number (VIN), the year, make and model, the series and body type (e.g., sedan, sport utility vehicle, van, or truck), the interior type, the interior and exterior colors, accessories and options, the transmission type, as well as the mileage and the condition of the vehicle. The dealership may also capture one or more photos of the vehicle, which may form a part of the information or data input. Vehicle information entered should be sufficient to determine the proper market value of the vehicle offered for sale.

The vehicle information may be collected by first completing physical forms and/or reports and then entering information from the physical forms and/or reports into data fields on the dealership computer 22. Alternatively, the information may be collected in a single step, such as by entering the vehicle information directly into data fields, as the information is collected, such as with the use of a hand-held or other electronic device.

The Vehicle Identification Number (VIN) can be used to determine the vehicle information by mapping the VIN with a Universal Vehicle Code (UVC) for the buyer vehicle. The UVC may be accessed through a third-party database server 28 and/or stored on the dealership computer 22 or the database 12. The VIN and the UVC are vehicle-specific. Therefore, given the VIN and the UVC, as is known in the art, the year, make and model of the vehicle, as well as the accessories with which the vehicle was manufactured, can be determined. Data fields may be automatically populated with this vehicle information.

It is known in the art to determine wear and tear as a function of mileage and repair history for the vehicle. The dealership may be prompted to enter the vehicle mileage into an appropriate data field and to add any post-manufacture accessories to appropriate fields, as well as a history of substantial repairs. Substantial repairs are those sufficiently significant to materially affect the value of the vehicle. Such repairs could be frame damage, repeated transmission problems, replaced engine or frame parts, or the like. At this time, the dealership may wish to provide a photo of the vehicle.

In step 120, the dealership appraises the value of the vehicle based on the information collected. Book value information may be derived from various third party sources, including third-party printed publications or third-party database servers 28 accessible by the dealership computer 22.

The third party sources provide book value information in the form of trade-in, retail, and private party sale and values. A trade-in value is the amount a consumer can expect to receive from the dealership for a trade-in vehicle. A retail value is the value that is representative of the dealership's asking price for a vehicle. A private party sale value is the amount a buyer can expect to pay when buying a used car from a private party seller. The trade-in value is a starting point for negotiation between a customer and the dealership.

It should be appreciated that the vehicle trade-in value may be determined in any suitable manner, as long as the manner for determining the trade-in value is consistent and objective. The vehicle trade-in value may be determined based on the vehicle information and the book value as provided by third party sources, or based on a formula stored in the dealership computer 22 or the database 12. A trade-in value based on third party sources or formulas may be adjusted if the dealership believes the value as determined is inappropriate.

Once a trade-in value is determined, the dealership offers to take the customer's vehicle for trade as partial payment toward the new vehicle. The customer may accept the trade-in value, negotiate the trade-in value up, or refuse to accept the trade-in value. If the trade-in value is not acceptable to the customer, no trade takes place, and no sale takes place. The customer leaves the dealership.

According to step 132, the dealership publishes the customer vehicle information (e.g., the year, make and model, the mileage and general condition, the VIN, and pictures) online via the database 12, wherein the customer vehicle information is searchable via the private party computer 24 by a private party buyer who may be interested in buying the vehicle.

The provision of security measures allows the dealership to associate the vehicle information with information about the dealership. That is to say, the vehicle information and value, together with the associated dealership information (e.g., an account number and/or user name and password, and the like), are stored in database 12. Additionally, information (e.g., date and time, and the like) associated with the submission may be stored on the database 12. This way, all of the vehicles originating from the same dealership can be aggregated to enable dealerships to identify and monitor all of the vehicles submitted. The dealership may also assign vehicles to an inventory to which the dealership is provided access via a web page generated by servers 26. The web page may be accessed by the dealership utilizing conventional browsers on the dealership computer 22. The web page may include GUI fields for providing information regarding vehicles offered for sale.

The customer vehicle information is searchable via the private party computer 24 by a private party buyer. A private party buyer who may be interested in buying the vehicle provides contact information, which is stored for access by the dealership.

In step 136, the dealership receives the contact information and notice that the private party buyer may be interested in buying the vehicle.

In step 138, the dealership notifies the customer that the private party buyer may be interested in buying the vehicle.

In accordance with step 140, the dealership makes a connection between the customer and the private party buyer (e.g., provides the customer the contact information of the private party buyer or provides the private party buyer the contact information of the customer).

The system and method described above make use of trade information that otherwise would go unused. In accordance with the system and method, a private party buyer can search for a vehicle, which has been recently considered for trade at a dealership, and which otherwise would not be for sale. Private party buyers are introduced to private party sellers who have vehicles for sale that were not traded in, vehicles of which the private party buyers otherwise would have no knowledge. That is to say, the system and method bring together people who otherwise would not be able to find each other.

Once a possible match has been made in the private sector (i.e., between private party buyers and sellers), the dealership will be notified, and the dealership will in turn notify the private party seller. This allows the buyer to buy a vehicle for thousands less than the retail sale price at a dealership. In other words, a private party buyer can avoid buying the vehicle from a dealership and paying full retail value (i.e., the dealership sale price).

There is no pressure to return to the dealership because the sale is a private sale between the buyer and seller. This allows the dealership to improve its goodwill with its customers. Providing the customer with an opportunity to privately sell his or her vehicle will bring the dealership into the forefront of the customer's mind. The dealer may gain back an interested and familiar customer, who is in need of a car and in a better financial position to buy a car.

In addition to putting together buyers and sellers, the system and method present an opportunity to introduce buyers to lending institutions, service centers and service providers, and retailers, while at the same time allow a host to generate online advertising revenue.

It should be understood that the system may include a plurality of first data storage devices (i.e., dealership computers 22), each located at a respective one of a plurality of dealerships. A plurality of inputs (e.g., keyboards, memory devices (i.e., a CD ROM, a flash card, or the like), handheld devices, or any other known input devices) may be provided, wherein each input is located at a respective one of the dealerships for entering data into a respective one of the first data storage devices. The data may comprise one or more data items selected from the group consisting of vehicle information items, book values, and vehicle photos.

A second data storage device (i.e., a centralized server 26) is located remotely from one of the plurality of first data storage devices (i.e., dealership computers 22), although it is possible that the second storage device could be located at one of the dealerships. The second data storage device is connected (i.e., hardwired or wirelessly, via the Internet, etc.) to one or more of the first data storage devices for receiving the data from the first data storage devices.

The second data storage device is connected (e.g., hardwired or wirelessly, or by the Internet via a web browser) to one or more customer portals (via the private party computers 24) to access the data on the second data storage device and initiate contact with a respective one of the dealership computers (i.e., through the centralized server 26).

Generally speaking, data may be collected at a plurality of dealerships via a plurality of devices. These devices provide the data to a device at a location remote from the dealerships. The remotely located device stores the data from the various dealerships so that the data is associated with the dealerships that provided the data. The data is accessible by private party buyers via yet another device that is remotely located from the other devices.

It should be appreciated that data in the form of appraisal information may be entered into a database by the dealership during or following an appraisal of a vehicle that is considered for trade. If the vehicle is not traded in, the appraisal information may be accessed by, or loaded to, a centralized server, which is remote from the dealership database. The appraisal information is made available to private party buyers remote from the centralized server via a customer portal (e.g., a private party computer) via the Internet by a web browser. A private party buyer may express an interest in a vehicle. This triggers some form of notification to the dealership that is the source of the appraisal information. The dealership in turn contacts the private party seller to inform the seller of the buyer's interest. Alternatively, the dealership may provide the private party seller or buyer with information to enable one to contact the other, or the dealership may otherwise put the private party buyer and the private party seller together.

In accordance with the provisions of the patent statutes, the principle and mode of operation of the device and method steps have been explained and illustrated as exemplary embodiments. However, it must be understood that the device may be practiced otherwise than as specifically explained and illustrated without departing from its spirit or scope.

What is claimed is:

1. A system for use in introducing a private party buyer to a private party seller of a vehicle that was considered as a trade toward a new vehicle, the system comprising:
a dealership computer into which vehicle information is entered for ascertaining a trade-in value for a private party vehicle; and
a private party computer located remotely from the dealership computer, the private party computer being connected to the dealership computer, the private party computer publishing the vehicle information on the private party computer to solicit a private party buyer for the private party vehicle.

2. The system according to claim 1, further comprising:
a database; and
a server, the dealership computer being located at a dealership remote from the server and the database, the dealership computer being connected to the server via the Internet to store the vehicle information in the database for publishing on the private party computer.

3. The system according to claim 2, wherein the dealership computer is one of a plurality of dealership computers into which vehicle information is entered for ascertaining the trade-in value of a plurality of vehicles, the dealership computers being located at a plurality of dealerships remote from the server and the database, the dealership computers being connected to the server via the Internet to store the vehicle information in the database.

4. The system according to claim 2, wherein the private party computer is one of a plurality of private party computers located remotely from the dealership computer, the private party computers being connected to the dealership computer via the Internet, the private party computers publishing the vehicle information via the Internet by a web browser on the private party computers to solicit a private party buyer for the vehicle.

5. The system according to claim 2, wherein via the private party computer publishes the vehicle information via the Internet by a web browser on the private party computer.

6. A method for putting together a private party buyer and a private party seller to complete the sale of a vehicle based on trade-in appraisal information gathered by a dealership and made available to private party buyers, the method comprising the steps of:
a) a dealership publishing a customer's vehicle information on a computer network so that the information is searchable by a remotely located private party buyer,
b) the dealership receiving notice that the private party buyer may be interested in buying the customer's vehicle, and
c) the dealership notifying the customer that the private party buyer may be interested in buying the customer's vehicle.

7. The method according to claim 6, wherein step a) further comprises the step of the dealership obtaining the customer's consent to publish the customer's vehicle information.

8. The method according to claim 6, further comprising the step of the dealership collecting the customer's vehicle information.

9. The method according to claim 8, further comprising the step of the dealership appraising the trade-in value of the vehicle based on the customer's vehicle information.

10. The method according to claim 9, further comprising the step of the dealership offering an appraised trade-in value for the customer's vehicle that is not accepted by the customer.

11. The method according to claim 6, wherein step b) further comprises the step of the dealership receiving contact information from the private party buyer who may be interested in buying the customer's vehicle.

12. The method according to claim 6, wherein step c) further comprises the step of the dealership making a connection between the customer and the private party buyer.
